(19) United States
(12) Patent Application Publication
(10) Pub. No.: US 2004/0255044 A1
(43) Pub. Date: Dec. 16, 2004

(54) Network-aware application in a 4g environment

(76) Inventor: Martin Bergek, Goteborg (SE)

Correspondence Address: HARNESS, DICKEY & PIERCE, P.L.C., P.O. BOX 8910, RESTON, VA, 20195, US

(21) Appl. No.: 10/483,960

(22) PCT Filed: Jun. 28, 2002
(86) PCT No.: PCT/SE02/01287

(30) Foreign Application Priority Data
Jul. 16, 2001 (SE) 0102546-9

(51) Int. Cl. G06F 15/173

(52) U.S. Cl. 709/238

(57) ABSTRACT

The present invention relates to problem when moving between networks with maintained sessions and a solution to that problem. A method for improving data transmission efficiency in a network system comprising at least two processing units and at least one communication route connecting said units, one of the units being provided with a software application which in use communicates with the other unit through said communication route, comprises the steps of: receiving information about the characteristics of the communication route in said application; and adapting the operation of the application in response to said received information.

### FIELD OF THE INVENTION

The present invention relates to problem when moving between networks with maintained sessions and a solution to that problem.

### BACKGROUND

To date, networking using personal computers has been based on using dial-up networking (i.e. modem, cellular etc) or LAN (i.e. Ethernet, 802.11b etc). At each time of connection one such type is selected and for most of the time the same type is used at all times (e.g. stationary computers in an office). As a consequence there has not existed a clear reason for applications to be able to adapt to various network situations.

Future networks will be a heterogeneous mix of different network technologies. Because of this, solutions will emerge that give the possibility to move between the different networks seamlessly. Applications will be largely unaware of the movement between different networks. In this environment, applications would greatly benefit by being able to adapt to the varying network characteristics.

Within a foreseeable future, solutions will emerge, providing the ability for mobile nodes to move between different networks with maintained network identity and ongoing sessions in place. One such standard is Mobile IP that provides a means for mobile nodes to have a static network identity even though it may be connected to the network via different access points.

Even greater flexibility in network attachment is enabled with a multi-channel solution such as Icomera Gateway. In this case the mobile node is actually connected to the network using a multitude of devices simultaneously and uses one or more of those devices simultaneously to communicate.

When the network access is de-coupled from the applications using a solution such as the ones above, it will be increasingly difficult, if indeed not impossible, for applications to adapt to changes since the choice of network access is more or less completely hidden from the applications. Yet there exist a clear benefit for applications to be able to fully use the network capacity in the best possible manner and to be able to do so requires for the application to have some control of and to some extent be notified of changes in network attachment.

Mobility support is generally added below the network stack (e.g. TCP/IP). Mobile IP is one standard that usually is implemented below TCP/IP, presenting a single interface for TCP/IP. In the same manner Icomera Gateway presents a single network adapter to TCP/IP. This network adapter in turn communicates with the individual network devices (Ethernet, GPRS, etc) but that is invisible for both TCP/IP and the applications.

Although not usually done at present, mobility support (e.g. Mobile IP) could be implemented within the TCP/IP stack. One such scenario could be Mobile IP as implemented in IPv6, the possible future standard for IP traffic.

Currently there is not a general way for applications to be notified on and query for network status. Specifically this is true for:

Cost structure

Indications when high-bandwidth/low-cost areas are entered (and vice versa)

Whatever little information that today can be inferred using what is known about the different devices and checking which device is used at any one time will disappear when the communication is made completely transparent to the applications with various session mobility solutions (e.g. Mobile IP).

Some applications can be configured for either mobile or stationary mode and some use the fact that dial-up is usually slow and costly while wired access is usually fast and cost-free to choose how much to communicate. This will not be the case in a near future where dial-up connections can be anything from a GSM phone at 9.6 kbps to a 3 G terminal at a few Mbps, while network devices can range from very costly satellite links providing minimal capacity to fixed access in offices with bandwidth in excess of 100 Mbps. Furthermore those access methods will be bundled in a way that it is completely transparent for applications what network is used at any one time. This bundling of network devices is not done at present but will be available with the introduction of mobile IP and other technologies.

Due to the reason stated above it is not surprising that there does not at present exist a common way for applications to adapt to varying networks.

### OBJECT OF THE INVENTION

It is therefore an object of the present invention to provide a method and an apparatus to alleviate the above-discussed problems with the prior art.

This object is achieved by means of a method, a software application and an apparatus according to the enclosed claims.

### BRIEF DESCRIPTION OF THE DRAWINGS

For exemplifying purposes, the invention will be described in closer detail in the following with reference to embodiments thereof illustrated in the attached drawings, wherein:

FIG. 1 shows a block diagram of a network system according to an embodiment of the invention in which session mobility is included in the standard networking stack (e.g. TCP/IP). The network stack would in this case export an interface such that applications would be notified by the network stack and may use methods in the network stack to interact with the session mobility.

FIG. 2 shows a block diagram of a network system according to another embodiment of the invention in which session mobility is provided by a separate component that is inserted into the network stack below the ordinary communication protocol (e.g. TCP/IP). This component would in this case provide an interface that applications can use to be notified of changes and call to interact with the session mobility.,

FIG. 3 shows a block diagram of a network system according to another embodiment of the invention in which session mobility support includes external components that are not directly inserted into the communication stack. Such a component would provide an interface that applications can use to be notified of changes and call to interact with the session mobility.

FIG. 4 shows a block diagram of a network system according to another embodiment of the invention in which session mobility is provided by a separate component that is implemented on the transport level above the ordinary communication component (e.g. TCP/IP).

### FUNCTION OF THE INVENTION

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The benefit for applications to make better use of network access will now be exemplified with a few use-cases. This list is by no means exhaustive.

For cost reasons it will not be possible for wireless operators to provide wide area coverage using the highest bandwidth solutions. Instead high-capacity networks will give islands of coverage. Between these islands, other systems will provide network connectivity with lower bandwidths.

High capacity networks will be run in various locations:

Offices

Homes

Shopping malls

Train stations

Etc

Whenever people move into such an area applications would be triggered to perform tasks that are network-heavy. Such tasks could include:

Initiating synchronisations

Sending e-mails with big attachments

Starting applications that require high bandwidths (e.g. video clips in urban areas promoting movies)

Route incoming and outgoing calls via the high-bandwidth or low-cost network

Performing such tasks automatically would give better service for the user with optimal use of network capacity.

When outside any such area applications could then change their operation to be more cost-aware for the users. In this case applications could switch to a mode where only parts of the data is downloaded.

Just as applications would benefit from knowing when changing between different types of networks, so too they would benefit by adapting to changes in pricing structure on individual network devices.

When accessing the network via a single network device the application would in this case be notified if a change has happened in the pricing structure on the connected device. It could for instance be a device that is free to use in the evening but carries a cost during daytime. The application would in this case be notified when the cost is increased or decreased and can react appropriately.

Transfers involving big amounts of data could then be done automatically at the appropriate time using the appropriate device and any configuration necessary on the terminal side would be within the mobility solution as extended by this patent.

All access networks carry with them certain latency, the amount of time it takes to send an infinitesimal small packet to a destination device. For some applications it is highly beneficial to know when this time is small enough to enable certain applications to run on top of it. One such application is voice over IP (VoIP), which could be operated on WLAN. Cellular networks, on the other hand are not likely to provide latencies low enough to allow sufficient voice quality. A phone application in a device with access to both WLAN and cellular could then accept calls using VoIP over WLAN when within coverage and use normal cellular at other times. For the end-user this could allow better price performance since the cellular operator's pricing scheme could be circumvented.

Many devices are capable of determining their whereabouts. This function can be implemented in future mobile phones, wireless access devices, separate positioning devices (e.g. GPS) etc. Regardless of which network devices are being used to communicate this user scenario enables the user to use the positioning function of one device while transferring data using another device. As a typical case it could include being attached with both WLAN and GPRS using a system such as Icomera Gateway, only using WLAN for transferring data while positioning the user with GPRS. Such a service would be a big advantage for cellular network operators who could then position their customers while avoiding to use their limited mobile spectrum to deliver data since that would be done much more efficiently using WLAN or another technology.

Every connected device is identified by its network identity. This identity can belong to the public or a private address domain (i.e. global Internet addresses or addresses behind a corporate NAT). With future technologies that hide changes in network identity on individual network devices and present a common identity for services and applications the network identity will almost always be static. In certain scenarios, however, the identity would be changed, something that applications and the operating system should be notified of. An example of such a scenario is when one device wants to assume the network identity of another device.

The change in network identity could be initiated by the system itself, by applications or by external events.

Preferred Embodiments

The function of the proposed solution is two-fold:

Firstly, to provide means for applications to be notified of current status or changes in the system such as:

The mobile node has switched to a network device with high bandwidth

The mobile node has switched to a network device with low bandwidth

Current cost for transferring data

Current bandwidth

Current latency

Current network identity

Current location of the user—regardless of which network device is currently assigned to be used for data transfer, one or more of the available network devices could be used for acquiring a position of the user for location based services secondly, to provide means for applications to:

Initiate a handover (if another network access method is available or thought to be available)

Initiate a search for a more suitable network access method

Indicate a need for amount of bandwidth

Indicate a willingness to pay extra for higher bandwidth (could be achieved by changing network or by re-attaching to a current network with a higher QoS level)

Indicate end of willingness to pay extra for higher bandwidth (would lead to establishing the most cost-efficient network access)

Set preferred parameters for the communication (cost in relation to provided bandwidth, latency etc)

Set event masks to select levels at which events will be fired (e.g. level at what is regarded as high bandwidth, low latency etc)

Initiate a change of network identity (e.g. acquiring a new network identity or releasing the current network identity)

Although the functions described in this document mainly focuses on wireless network access methods, they are by no means restricted to wireless but may just as well include all available network accesses. The main benefit however exists for wireless networking since there the differences in bandwidth and cost are greatest.

Implementation Example

The implementation of the mobility support will normally be:

a Network drivers below TCP/IP

a TCP/IP driver with mobility support included

Coupled with this may be secondary implementations for graphical user handling, connection logics etc. This may or may not operate in user mode in the operating system. The function described in this document can be implemented in either of these components or as a third component implemented separately from the others.

The appended drawings illustrate a few of the possible ways the function described in this document may be implemented in relation to other relevant components in the client device.

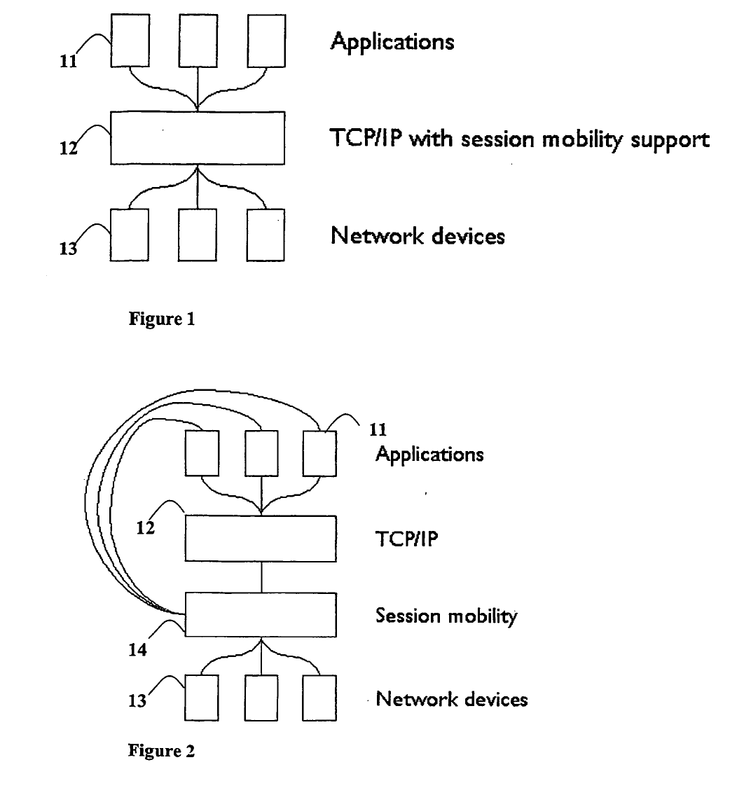

FIG. 1: Session mobility may be included with the standard networking stack 12 (e.g. TCP/IP). The network stack would in this case export an interface such that applications 11 would be notified by the network stack and may use methods in the network stack to interact with the session mobility.

FIG. 2: Session mobility may be provided by a separate component 14 that is inserted into the network stack below the ordinary communication protocol 12 (e.g. TCP/IP). This component would in this case provide an interface that applications 11 can use to be notified of changes and call to interact with the session mobility 14.

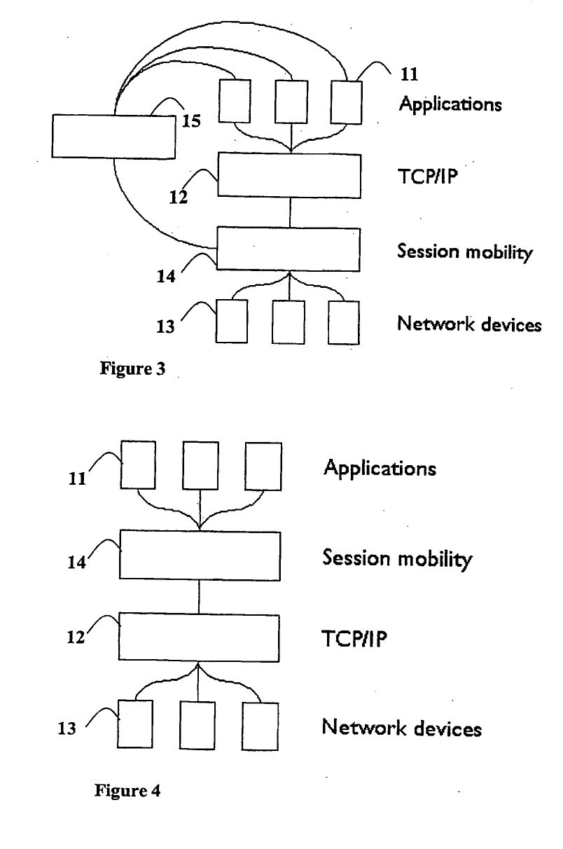

FIG. 3: Session mobility support could include external components 15 that are not directly inserted into the communication stack 12. Such a component would provide an interface that applications 11 can use to be notified of changes and call to interact with the session mobility 14. The same component could be co-implemented with support for GUI handling or other functions. This case is equivalent with a scenario where session mobility is implemented within the TCP/IP stack but the interface for applications is provided by another component.

FIG. 4: Session mobility may be provided by a separate component 14 that is implemented on the transport level above the ordinary communication component 12 (e.g. TCP/IP). In Windows this could be done as part of, or as a replacement to, WinSock. Such a component would provide an interface that applications can use to be notified of changes and call to interact with the session mobility. The same component could be used for GUI or other functions.

Regardless of where the function is implemented it would typically include:

A function to register applications that will then receive notifications

A function to deregister applications that will then not receive any more notifications

A possibility to listen to system-wide broadcasts of network changes

An interface to poll the current status

Functions that affect the mobility function as described above

The interface between the different components (driver, GUI interface and the function described by this document) above could be any type of interface that is available on the operating system in question. Since they might be implemented in a single process they could even interact directly with each other. The exact definition of how the components interact with each other is implementation-specific The interface towards external applications, and possibly towards the operating system, could be any defined type of interface in the operating system in question. For Windows it could be (depending on where the function this document describes is implemented):

COM/DCOM

DeviceIoControl-calls

Window messages

Any other inter-process method

For other operating systems any similar systems for inter-process communication could be used for the interface.

Example Interface

An example of using COM to interface a function such as this could be as described with the following MIDL file:

[

object,
uuid (F25E04DC-1EF5-457D-B9BC-BB5D68E64EC4),
helpstring(“ISink Interface”),
pointer_default (unique)

]
interface ISink : IUnknown
{

HRESULT OnEnterLowBandwidth ( );
HRESULT OnEnterHighBandwidth ( );
HRESULT OnNewPricing (LPUNKNOWN pPriceInfo);
HRESULT OnNewLatency (LPUNKNOWN pLatencyInfo);
HRESULT OnNewBandwidth (LPUNKNOWN pBandwidthInfo);
HRESULT OnLocationUpdate (LPUNKNOWN pLocationInfo);
HRESULT OnAcquireIdentity (LPUNKNOWN pIdentityInfo);
HRESULT OnReleaseIdentity (LPUNKNOWN pIdentityInfo);

};
[

object,
uuid (F068422C-BA61-4166-B479-639182EF9A40),
helpstring (“ISource Interface”),
pointer_default (unique)

]
interface ISource : IUnknown
{

HRESULT Advise ([in] ISink* pEvents, [out] long* pCookie);
HRESULT Unadvise ([in] long cookie);
HRESULT Connect ( );
HRESULT Disconnect ( );
HRESULT InitiateHandover (LPUNKNOWN pHandoverInfo);
HRESULT AcquireIdentity (LPUNKNOWN pIdentityInfo)
HRESULT ReleaseIdentity (LPUNKNOWN pIdentityInfo)
HRESULT MaximumBandwidth ( );
HRESULT MinimimCost ( );
HRESULT SetPreferredCostBandwidth (LPUNKNOWN

pCostBandwidthInfo);

HRESULT SetEventMasks (LPUNKNOWN pEventMasks)

};

In the above example the client application would register itself in the function as described in this document by a call to “Advise” and would later receive notifications as described in the ISink interface. At any time the client application could in this example call the methods defined in the ISource interface to interact with the session mobility system. When the client application no longer wishes to receive notifications it would call “Unadvise”.

1. A method for improving data transmission efficiency in a network system comprising at least two processing units and at least one communication route connecting said units, one of the units being provided with a software application which in use communicates with the other unit through said communication route, comprising the steps of:
receiving information about the characteristics of the communication route in said application; and
adapting the operation of the application in response to said received information.

2. A method according to claim 1, wherein the units are connected by at least two communication routes, wherein the received information relates to characteristics about said communication routes.

3. A method according claim 1, wherein the choice of communication route to be used for transmission is transparent to the application.

4. A method according to claim, wherein the characteristics of the communication route to which said information is related varies over time.

5. A method according to claim 1, wherein the information comprises at least one of latency, bandwidth, transmission cost, location and position of the unit comprising the application and network identity of the unit comprising the application.

6. A method according to claim 1, wherein the transmission operation of the application is adapted, in response to said received information.

7. A method according to claim 6, wherein the amount of data transmitted is restricted as a function of the received information.

8. A method according to claim, wherein the timing of data transmission is controlled as a function of the received information.

9. A method according to claim 1, wherein the application initiates a change of network identity in response to said received information.

10. A method according to claim 1, wherein the application initiates a change of network access in response to said received information.

11. A method according to claim 1, wherein the information about the communication route is received as broadcast information sent to the application by a communication route status provider.

12. A method according to claim 1, wherein the application polls a communication route status provider to receive information.

13. An apparatus, coupled to a network, comprising:
a computer software application; and
processing means for running said application, wherein the application during operation is adapted to communicate with at least one other unit through a communication route in said network, and wherein the application is adapted to receive information about the characteristics of the communication route and to adapt the operation of the application in response to said received information.

14. An apparatus according to claim 13, wherein the units are connected by at least two communication routes, wherein the received information relates to characteristics about both communication routes.

15. An apparatus according to claim 14, further comprising a network adapter for managing the transmission through said communication routes, and with a single interface to the application, whereby the choice of communication route to be used for transmission preferably is transparent to the application.

16. An apparatus according to claim 13, wherein said information is provided by a communication route status provider.

17. An apparatus according to claim 16, wherein the communication route status provider enables registration and deregistration of applications to be informed about communication route status.

18. An apparatus according to claim 13, wherein the characteristics of the communication route to which said information is related varies over time.

19. An apparatus according to claims 13, wherein the information comprises at least one of latency, bandwidth, transmission cost, location and position of the unit comprising the application and network identity of the unit comprising the application.

20. A computer software application to be used in a computer network system, said software application comprising programming steps to inter-communicate with at least one other unit connected to said network system through at least one communication route, and programming steps to receive information about characteristics about the communication route and to adapt the operation of the application in accordance with said received information.

21. A method according claim 2, wherein the choice of communication route to be used for transmission is transparent to the application.

22. A method according to claim 2, wherein the characteristics of the communication route to which said information is related varies over time.

23. A method according to claim 2, wherein the information comprises at least one of latency, bandwidth, transmission cost, location and position of the unit comprising the application and network identity of the unit comprising the application.

24. A method according to claim 1, wherein the transmission operation of the application is automatically adapted in response to said received information.

25. A method according to claim 7, wherein the timing of data transmission is controlled as a function of the received information.

26. A method according to claim 2, wherein the application initiates a change of network identity in response to said received information.

27. A method according to claim 2, wherein the application initiates a change of network access in response to said received information.

28. A method according claim 2, wherein the information about the communication route is received as broadcast information sent to the application by a communication route status provider.

29. A method according to claim 2, wherein the application polls a communication route status provider to receive information.

30. An apparatus according to claim 14, wherein said information is provided by a communication route status provider.

31. An apparatus according to claim 15, wherein said information is provided by a communication route status provider.

32. An apparatus according to claim 14, wherein the characteristics of the communication route to which said information is related varies over time.

33. An apparatus according to claim 14, wherein the information comprises at least one of latency, bandwidth, transmission cost, location and position of the unit comprising the application and network identity of the unit comprising the application.
